(19) United States
(12) Patent Application Publication
(10) Pub. No.: US 2021/0062549 A1
(43) Pub. Date: Mar. 4, 2021

(54) MECHANICAL SECURITY FEATURE FOR A HOUSING

(71) Applicant: Johnson Controls Technology Company, Auburn Hills, MI (US)

(72) Inventors: Daulat Dattatray Shelke, Pune (IN); Wesley Irek, Greenfield, WI (US); Sriganesh Thangavel Chandrasekaran, Tiruchirappalli (IN); Mayuresh Yashodhan Sapre, Pune (IN); Lakhan Shivaji Doke, Pune (IN)

(73) Assignee: Johnson Controls Technology Company, Auburn Hills, MI (US)

(21) Appl. No.: 16/550,503

(22) Filed: Aug. 26, 2019

(51) Int. Cl. E05B 63/00; E05B 73/00

(52) U.S. Cl. CPC E05B 63/0052; E05B 63/24; E05B 73/0023

(57) ABSTRACT

A housing includes an upper housing member, a lower housing member, a first interlocking member, and a second interlocking member. The first interlocking member includes an engagement portion, and a first interlocking portion. The engagement portion is at a proximate end and is configured to engage a corresponding contact surface of the upper housing member. The first interlocking portion is at a distal end. The second member extends from the lower housing member into an inner volume of the upper housing member. The second interlocking member includes an opening and a second interlocking portion. The opening is positioned between a proximate end and a distal end of the second interlocking member. The window is configured to at least partially receive the first interlocking portion of the first interlocking member. The second interlocking portion is configured to engage a corresponding engagement portion of the upper housing member.

### BACKGROUND

The present disclosure relates generally to mechanical security features for housings. More specifically, the present disclosure relates to a tamper evident mechanical security feature.

### SUMMARY

One implementation of the present disclosure is a mechanical security feature for a housing, according to some embodiments. In some embodiments, the mechanical security feature includes a first interlocking member and a second interlocking member. In some embodiments, the first interlocking member includes a shoulder and a first hook. In some embodiments, the shoulder is at a proximate end and is configured to engage a corresponding shoulder of a first housing member. In some embodiments, the first hook at a distal end. In some embodiments, the second interlocking member comprises a proximate end and a distal end. In some embodiments, the second interlocking member extends from a second housing member into an inner volume of the housing defined by the first housing member and the second housing member. In some embodiments, the second interlocking member includes a second hook, and a window. In some embodiments, the second hook is at the distal end and is configured to engage a corresponding engagement surface of the first housing member. In some embodiments, the window is positioned between the distal end and the proximate end. In some embodiments, the window is configured to receive the hook of the first interlocking member to fix the first housing member with the second housing member.

In some embodiments, the second interlocking member is fixedly coupled with the second housing member.

In some embodiments, the second interlocking member is integrally formed with the second housing member.

In some embodiments, the first interlocking member is red.

In some embodiments, the first interlocking member includes a third hook. In some embodiments, the first and third hooks are positioned at distal ends of a pair of elongated members of the first interlocking member.

In some embodiments, the first and third hooks are configured to engage windows of the second interlocking member positioned on opposite sides of the first interlocking member.

In some embodiments, the first interlocking member includes a head at the proximate end that defines the shoulder of the first interlocking member.

In some embodiments, the head is a rectangular shape.

In some embodiments, the head is configured to be received within a recess of the first housing member having a corresponding shape.

In some embodiments, the corresponding engagement surface of the first housing member that the second hook of the second interlocking member engages is defined by an aperture in a wall that extends from the first housing member into the inner volume of the housing.

Another implementation of the present disclosure is a mechanical security feature for a housing, according to some embodiments. In some embodiments, the mechanical security feature includes a first interlocking member and a second interlocking member. In some embodiments, the first interlocking member includes a surface at a proximate end configured to engage a corresponding contact surface of a first housing member. In some embodiments, the first interlocking member includes a first protrusion at a distal end. In some embodiments, the second interlocking member includes a proximate end and a distal end. In some embodiments, the second interlocking member extends from a second housing member into an inner volume of the housing defined by the first housing member and the second housing member. In some embodiments, the second interlocking member includes a second protrusion and a window. In some embodiments, the second protrusion is at the distal end and is configured to engage a corresponding engagement surface of the first housing member. In some embodiments, the window is positioned between the distal end and the proximate end. In some embodiments, the window is configured to receive the first protrusion of the first interlocking member to fix the first housing member with the second housing member.

In some embodiments, the second interlocking member is fixedly coupled with the second housing member.

In some embodiments, the second interlocking member is integrally formed with the second housing member.

In some embodiments, the first interlocking member is red.

In some embodiments, the first interlocking member includes a third protrusion. In some embodiments, the first and third protrusions are positioned at distal ends of a pair of elongated members of the first interlocking member.

In some embodiments, the first and third protrusions are configured to engage windows of the second interlocking member positioned on opposite sides of the first interlocking member.

In some embodiments, the first interlocking member includes a head at the proximate end that defines the contact surface of the first interlocking member.

In some embodiments, the head is a rectangular shape and is configured to be received within a recess of the first housing member having a corresponding shape.

In some embodiments, the corresponding engagement surface of the first housing member that the second protrusion of the second interlocking member engages is defined by an aperture in a wall that extends from the first housing member into the inner volume of the housing.

Another implementation of the present disclosure is a housing, according to some embodiments. In some embodiments, the housing includes an upper housing member, a lower housing member, a first interlocking member, and a second interlocking member. In some embodiments, the first interlocking member includes an engagement portion, and a first interlocking portion. In some embodiments, the engagement portion is at a proximate end and is configured to engage a corresponding contact surface of the upper housing member. In some embodiments, the first interlocking portion is at a distal end. In some embodiments, the second member extends from the lower housing member into an inner volume of the upper housing member. In some embodiments, the second interlocking member includes an opening and a second interlocking portion. In some embodiments, the opening is positioned between a proximate end and a distal end of the second interlocking member. In some embodiments, the window is configured to at least partially receive the first interlocking portion of the first interlocking member. In some embodiments, the second interlocking portion is configured to engage a corresponding engagement portion of the upper housing member.

### BRIEF DESCRIPTION OF THE DRAWINGS

FIG. 1 is a perspective view of a controller assembly with a mechanical security feature, according to some embodiments.

FIG. 2 is an exploded perspective view of the controller assembly of FIG. 1, according to some embodiments.

FIG. 3 is a side sectional view of the mechanical security feature of the controller assembly of FIG. 1, according to some embodiments.

FIG. 4 is a perspective view of the mechanical security feature of the controller assembly of FIG. 1 in a test assembly, according to some embodiments.

FIG. 5 is a perspective view of an interlocking member of the mechanical security feature of the controller assembly of FIG. 1, according to some embodiments.

FIG. 6 is a perspective sectional view of the mechanical security feature of the controller assembly of FIG. 1, according to some embodiments.

FIG. 7 is a perspective view of an interlocking member of the mechanical security feature of the controller assembly of FIG. 6, according to some embodiments.

FIG. 8 is a perspective sectional view of the mechanical security feature of FIG. 6, according to some embodiments.

FIG. 9 is a perspective view of an interlocking member of the mechanical security feature of FIGS. 3-4, according to some embodiments.

### DETAILED DESCRIPTION

Before turning to the FIGURES, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

### Overview

Referring generally to the FIGURES, a snap shim, a mechanical security feature, a tamper resistant feature, etc., for a housing are shown, according to some embodiments. In some embodiments, the mechanical security feature is configured to prevent or facilitate preventing unauthorized access to the interior of the housing. In some embodiments, the mechanical security feature includes a first latch member and a receiving member. The first latch member includes a head that defines a step or a shoulder that engages a corresponding shoulder or surface of a housing member, according to some embodiments. In some embodiments, the first latch member is configured to be received within a corresponding aperture, recess, window, hole, opening, etc., of an upper housing member of the housing. In some embodiments, the housing has a clam-shell configuration with a lower housing member that secures (e.g., fixedly couples) with the upper member.

In some embodiments, the latch member includes a hook, an interfacing portion, a latch, etc., at an end portion that extends into the interior of the housing. In some embodiments, the hook is configured to be received within a correspondingly shaped and appropriately positioned window or opening in the receiving member. In some embodiments, the receiving member fixedly couples with the lower housing member and extends into the interior of the housing from the lower housing member. In some embodiments, the receiving member includes a latch, a hook, an interfacing member, an interfacing portion, etc., at an end that extends into the interior of the housing. In some embodiments, the hook of the receiving member is configured to be received within and engage a corresponding portion of the upper housing member. In some embodiments, the portion of the upper housing member that the hook of the receiving member engages is defined by a window of a wall of the upper housing member.

In some embodiments, the receiving member is integrally formed with the lower housing member. Advantageously, the mechanical security feature provides several points of engagement that fixedly couple the lower housing member with the upper housing member. The hook of the latch member engages a corresponding surface (e.g., a surface of the window) of the receiving member which is fixedly coupled with the lower housing member, thereby fixing the upper and the lower housing member, according to some embodiments. Additionally, the latch or hook of the receiving member is configured to engage or contact a corresponding surface of the window of the upper housing member, thereby providing an additional fixation point between the upper housing member and the lower housing member, according to some embodiments. In this way, even if the latch member or the receiving member are removed, the other point of fixation between the upper and the lower housing member maintains the secure fixation therebetween.

### Controller Housing

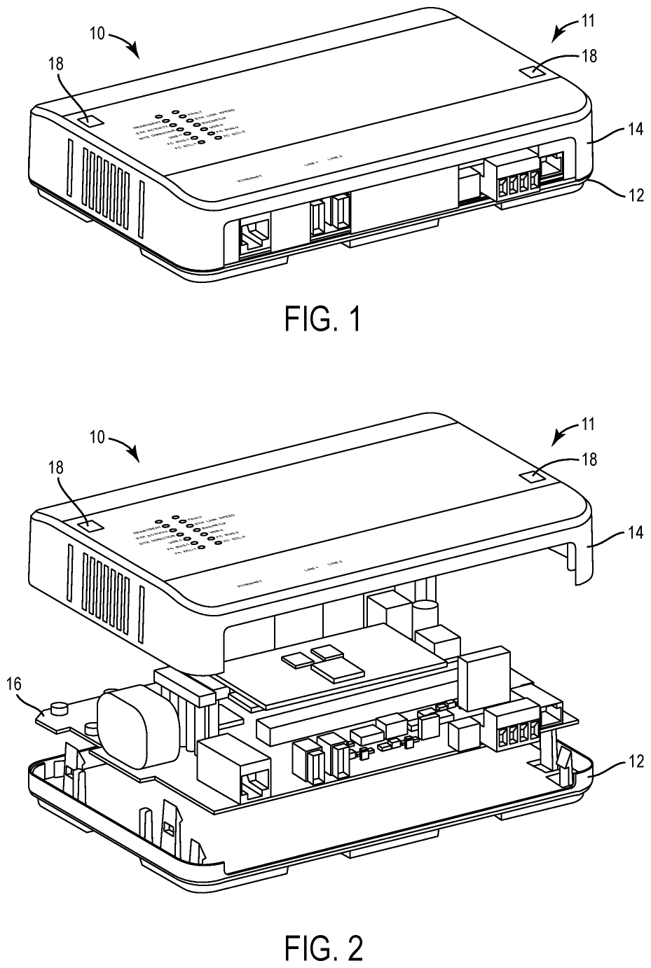

Referring now to FIGS. 1-2, a controller assembly 10 includes a housing, a container, an enclosure, a body, a shell, a protective member, a casing, a construction, a sleeve, a jacket, a capsule, etc., shown as housing 11. Housing 11 is configured to protect and enclose a processing circuit, a controller, a processing unit, valuable components, internal components, etc., of controller assembly 10, shown as controller 16. It should be understood that while controller 16 is shown as a processing circuit including various electrical components, housing 11 can be configured to enclose, protect, etc., any other components or valuables. In some embodiments, housing 11 is manufactured from a plastic material (e.g., ABS plastic, PVC plastic, etc.).

Controller 16 can be configured to operate building equipment (e.g., heating, ventilation and/or air conditioning (HVAC) equipment) to affect an environmental condition of a space. In some embodiments, controller 16 is a processing unit configured to perform data analysis, data processing, etc., and provide outputs to another computing device, controller, equipment, etc.

It is often desirable to prevent controller 16 from being tampered with by unauthorized individuals. Advantageously, housing 11 provides a tamper resistant physical barrier between controller 16 and unauthorized individuals, according to some embodiments. Housing 11 is configured to be tamper resistant such that controller 16 cannot be accessed by unauthorized individuals, according to some embodiments. In some embodiments, housing 11 is also tamper evident. For example, if controller assembly 10 is tampered with by an unauthorized or malevolent individual, various physical features of controller assembly 10 (or more specifically, housing 11) can provide visual indications that controller assembly 10 has been tampered with. This enables an inspector to visually determine if controller assembly 10 has been tampered with, according to some embodiments.

Housing 11 includes a lower member, a bottom member, a base member, a first member, a first housing member, etc., shown as lower housing member 12, according to some embodiments. In some embodiments, housing 11 includes an upper member, a top member, a cover member, a second member, an upper housing member, a top housing member, etc., shown as upper housing member 14. In some embodiments, lower housing member 12 and upper housing member 14 are configured to removably and/or fixedly couple with each other to define an inner volume therewithin. In some embodiments, controller 16 is positioned within the inner volume defined by lower housing member 12 and upper housing member 14. In some embodiments, lower housing member 12 and upper housing member 14 are configured to removably fixedly couple with each other using snapping features, latches, a press fit, a slip fit, fasteners, etc. In some embodiments, lower housing member 12 and upper housing member 14 are correspondingly shaped such that lower housing member 12 and upper housing member 14 interlock to form housing 11. In some embodiments, lower housing member 12 and upper housing member 14 are configured to interlock through one or more interlocking features that extend along a perimeter of lower housing member 12 and upper housing member 14. In some embodiments, lower housing member 12 and upper housing member 14 are shell-shaped members and are configured to cooperatively couple with each other to enclose controller 16 therewithin.

Referring still to FIGS. 1 and 2, housing 11 includes two latches, coupling members, interfacing members, hooks, mechanical security features, tamper evident features, tamper resistant interfacing members, interlocking features, locking members, snaps, etc., shown as interlocking members 18, according to some embodiments. In some embodiments, interlocking members 18 are tamper resistant and provide additional fixing strength between lower housing member 12 and upper housing member 14. In some embodiments, two interlocking members 18 are used. In other embodiments, more or less than two interlocking members 18 are used. In some embodiments, interlocking members 18 are positioned about a perimeter of housing 11. In some embodiments, interlocking members 18 are positioned at opposite corners (e.g., a top left corner and a bottom right corner) of housing 11. In some embodiments, interlocking members 18 are positioned at all four corners of housing 11.

Interlocking members 18 are configured to secure, fix, fixedly couple, connect, etc., lower housing member 12 and upper housing member 14, according to some embodiments. In some embodiments, interlocking members 18 provide additional strength between lower housing member 12 and upper housing member 14, thereby improving the tamper resistance of housing 11. For example, interlocking members 18 can facilitate improving or increasing force required to remove upper housing member 14 from lower housing member 12, according to some embodiments. In some embodiments, interlocking members 18 are also tamper evident. For example, a technician can visually inspect housing 11 and interlocking members 18 to determine if housing 11 has been tampered with. Interlocking members 18 provide a visual indication regarding tampering with housing 11 as described in greater detail below, according to some embodiments.

### Security Latch

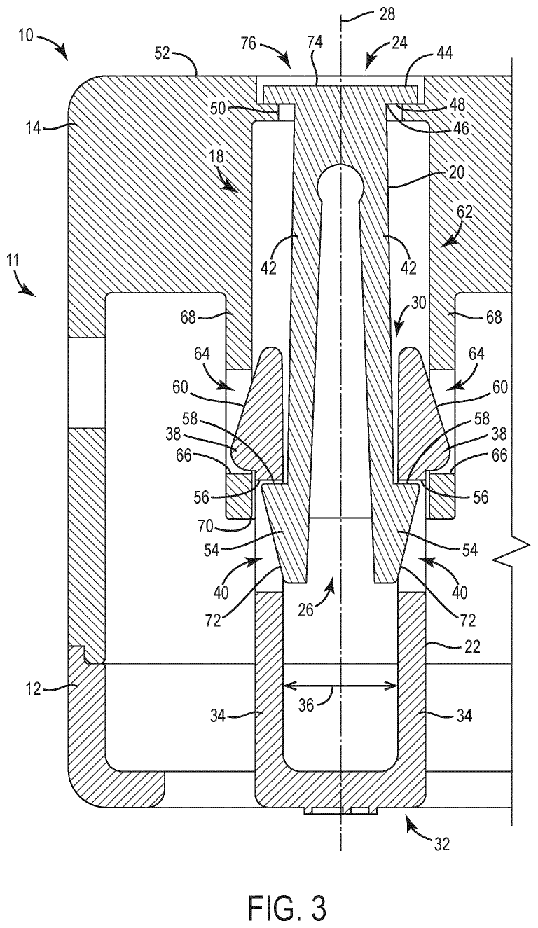

Referring particularly to FIGS. 3-5, interlocking members 18 are shown in greater detail, according to some embodiments. In some embodiments, interlocking member 18 includes a first latch, a first interlocking member, a first member, a snap, a snap shim, an upper member, etc., shown as latch member 20. In some embodiments, interlocking member 18 includes a second latch, a second interlocking member, a second member, a lower member, a receiving member, an interfacing member, etc., shown as receiving member 22. Receiving member 22 is configured to receive and fixedly couple (e.g., latch, interface, etc.) with latch member 20, according to some embodiments.

Receiving member 22 can be fixedly coupled, secured, attached, etc., with lower housing member 12 at a first, lower, proximate, or bottom end 32 of receiving member 22. In some embodiments, receiving member 22 is integrally formed with lower housing member 12. In some embodiments, receiving member 22 is fixedly coupled (e.g., adhered, fastened, etc.) with lower housing member 12. Receiving member 22 can be configured to extend through an aperture, a window, an opening, etc., in lower housing member 12. In some embodiments, receiving member 22 includes one or more interlocking features or interlocking geometry at first end 32 that are configured to engage or interlock with one or more corresponding interlocking features or geometry of lower housing member 12. In some embodiments, receiving member 22 is configured to receive latch member 20 at a second, upper, distal, or top end 30 of receiving member 22.

Receiving member 22 includes a pair of protrusions, elongated portions, elongated members, receiving members, tabs, etc., shown as elongated members 34. In some embodiments, elongated members 34 extend along longitudinal axis 28 that extends through a center of receiving member 22. In some embodiments, elongated members 34 are spaced a distance 36 apart (e.g., a lateral distance). In some embodiments, distance 36 is uniform (e.g., remains constant) along substantially an entire longitudinal height or length of elongated members 34. In some embodiments, distance 36 is non-uniform (e.g., increases linearly, decreases linearly, increases non-linearly, decreases non-linearly, follows a curved profile, etc.) along the entire longitudinal length of elongated members 34. In some embodiments, elongated members 34 extend upwards from lower housing member 12. In some embodiments, elongated members 34 are substantially parallel with each other. In some embodiments, elongated members 34 are non-parallel with each other.

Receiving member 22 can have a U-shape (as shown in FIG. 3), with elongated members 34 extending from a base portion of receiving member 22. In some embodiments, the base portion of receiving member 22 is fixedly coupled with an inner surface of lower housing member 12. In some embodiments, the base portion of receiving member 22 engages or contacts an interior surface of lower housing member 12.

Elongated members 34 can each include a window, an opening, an aperture, a square aperture, a receiving portion, etc., shown as receiving portion 40. In some embodiments, receiving portion 40 is a window that extends through an entire lateral thickness or width of elongated member 34. In some embodiments, receiving portion 40 is a recess that extends partially through the entire lateral thickness of elongated member 34. For example, receiving portion 40 can be a recess, an indent, etc., configured to receive a correspondingly shaped portion of latch member 20. In some embodiments, receiving portion 40 is a window that extends through the entire lateral thickness of elongated member 34 and is configured to receive a corresponding portion or a correspondingly shaped portion of latch member 20. In some embodiments, receiving portions 40 are positioned at a same lateral height along elongated members 34. In some embodiments, receiving portions 40 of elongated members 34 are symmetric.

Receiving portions 40 can be square or rectangular windows that extend through the entire lateral thickness of elongated members 34. In some embodiments, receiving portions 40 each define a surface, an engagement surface, etc., shown as engagement surface 56. In some embodiments, engagement surface 56 of elongated members 34 are substantially parallel to each other. In some embodiments, for example, engagement surfaces 56 are substantially horizontal planar surfaces. In some embodiments, engagement surfaces 56 are angled relative to a horizontal axis that is perpendicular to longitudinal axis 28. In some embodiments, engagement surfaces 56 of receiving portions 40 are configured to engage or contact a corresponding surface of latch member 20 to securely fix latch member 20 with receiving member 22.

In some embodiments, receiving member 22 is configured to engage, fixedly couple with, be inserted into, etc., an aperture, opening, window, inner volume, channel, track, etc., of upper housing member 14, shown as inner volume 62. Inner volume 62 can be defined by one or more longitudinally extending members, sidewalls, structural members, etc., of upper housing member 14, shown as sidewalls 68. In some embodiments, sidewalls 68 extend along longitudinal axis 28.

Sidewalls 68 each include an opening, an aperture, a window, a rectangular aperture, a rectangular window, a square opening, a recess, a depression, etc., shown as windows 64. In some embodiments, windows 64 extend through substantially an entire thickness of sidewalls 68. In some embodiments, windows 64 extend only partially through the entire thickness of sidewalls 68. Windows 64 are configured to receive and engage with a corresponding portion of receiving member 22. In this way, windows 64 facilitate securely fixing upper housing member 14 with receiving member 22 which can be fixedly coupled with lower housing member 12. In some embodiments, windows 64 each define an engagement surface, a contact surface, a shoulder, an edge, a face, etc., shown as contact surface 66. In some embodiments, contact surface 66 is configured to engage or contact a corresponding surface of receiving member 22.

Elongated members 34 can each include an end portion, an angled end portion, an angled tab, a flange, a protrusion, etc., shown as interfacing portions 38. In some embodiments, interfacing portions 38 are symmetric to each other. In some embodiments, interfacing portions 38 include an angled outer surface 60. In some embodiments, angled outer surface 60 is configured to engage or contact a corresponding surface, edge, portion, feature, etc., of receiving member 22 to facilitate fixedly coupling receiving member 22 with upper housing member 14.

In some embodiments, receiving member 22 can be inserted into inner volume 62 to fixedly couple receiving member 22 with upper housing member 14. In some embodiments, receiving member 22 is inserted into inner volume 62 along longitudinal axis 28. In some embodiments, as receiving member 22 is inserted into inner volume 62, angled outer surfaces 60 engage or contact a bottom edge, a bottom surface, a bottom shoulder, etc., of sidewalls 68. The engagement between angled outer surface 60 and the bottom shoulder of sidewalls 68 (e.g., shoulder 70) can cause elongated members 34 to bend, deflect, deform, etc. In some embodiments, as receiving member 22 is inserted into inner volume 62 of second body member 14, elongated members 34 deflect such that interfacing portions 38 are driven closer together (e.g., towards each other, to decrease a lateral distance therebetween interfacing portions 38, etc.). Elongated members 34 can deflect or bend towards each other such that interfacing portions 38 can be inserted or fit into inner volume 62. Once receiving member 22 is inserted fully into inner volume 62, elongated members 34 can return to a substantially straight or rest position. As elongated members 34 return to the substantially straight or the rest position, interfacing portions 38 snap into or are move into windows 64 to fixedly couple upper housing member 14 with receiving member 22. Engagement surface 56 of interfacing portions 38 can directly contact or engage contact surface 66 of upper housing member 14 to maintain secure fixation between upper housing member 14 and receiving member 22.

In some embodiments, receiving member 22 is fixedly coupled with lower housing member 12 after being inserted into inner volume 62 of upper housing member 14. In some embodiments, receiving member 22 is fixedly coupled with lower housing member 12 prior to being inserted into inner volume 62. For example, receiving member 22 can be fixedly coupled with lower housing member 12 and upper housing member 14 can be placed over or translated onto elongated members 34.

Referring still to FIGS. 3-5, latch member 20 can include a base portion, a head portion, a flat portion, a tab, etc., shown as head 44. Deformable members, elongated members, protrusions, interlocking members, etc., shown as bendable elongated members 42 protrude from head 44. Bendable elongated members 42 can extend from head 44 at an angle. In some embodiments, bendable elongated members 42 are configured to deflect, bend, deform, etc., to facilitate insertion of latch member 20 into receiving member 22. In some embodiments, bendable elongated members 42 are configured to be inserted into and interface with (e.g., fixedly couple with) receiving member 22. In some embodiments, bendable elongated members 42 each include an end portion, an interfacing portion, a protrusion, an interlocking portion, etc., shown as end portions 54.

End portions 54 of bendable elongated members 42 are configured to be received within and interlock with windows 40 of elongated members 34, according to some embodiments. In some embodiments, end portions 54 include an angled outer surface 72. Angled outer surface 72 is configured to engage an end portion, an end shoulder, etc., of elongated members 34 as latch member 20 is inserted, according to some embodiments. In some embodiments, angled outer surface 72 is configured to engage the end portion of elongated members 34 to drive bendable elongated members 42 to deflect or bend as latch member 20 is inserted into receiving member 22. Once latch member 20 is inserted fully into upper housing member 14, end portions 54 can snap or be driven into windows 40 of elongated members 34 of receiving member 22 due to rigidity or elasticity of bendable elongated members 42. In some embodiments, bendable elongated members 42 return to a rest position to snap end portions 54 into windows 40 of elongated members 34 to the configuration shown in FIG. 3. In some embodiments, as bendable elongated members 42 are inserted to interface or couple with receiving member 22, latch member 20 is secured with receiving member 22.

Latch member 20 facilitates securing or fastening or fixing upper housing member 14 with lower housing member 12, according to some embodiments. In some embodiments, head 44 defines a first or proximate end 24 of latch member 20. In some embodiments, head 44 is configured to engage, contact, secure with, etc., a corresponding surface 48 of upper housing member 14. In some embodiments, surface 48 of upper housing member 14 is sub-flush relative to an exterior or outer surface 52 of upper housing member 14. In some embodiments, surface 48 is sub-flush such that an outer surface 74 of head 44 is sub-flush relative to the exterior or outer surface 52 of upper housing member 14. In some embodiments, outer surface 74 of head 44 is flush with the exterior surface of upper housing member 14.

Surface 48 can be defined by an aperture, a recess, a window, a groove, etc., of upper housing member 14, shown as recess 76. Recess 76 has a shape that corresponds to a shape of head 44, according to some embodiments. In some embodiments, head 44 and recess 76 have a square shape, a rectangular shape, a circular shape, etc., or any other shape. In some embodiments, recess 76 has a perimeter or area that corresponds to the shape of head 44 but is larger (e.g., slightly larger) such that head 44 can be received within recess 76. In some embodiments, upper housing member 14 includes a window, an aperture, a hole, an opening, etc., shown as window 50. Window 50 can extend between surface 48 and inner volume 62. In some embodiments, window 50 is sized and shaped such that bendable elongated member 42 can extend therethrough. In some embodiments, window 50 defines a shoulder 46 that is configured to engage or contact a corresponding shoulder of head 44. In some embodiments, the corresponding shoulder or step of head 44 is defined by head 44 and bendable elongated members 42.

In this way, latch member 20 can be inserted into recess 76 and window 50 of upper housing member 14. Latch member 20 can be inserted into recess 76 and window 50 of upper housing member 14 until the shoulder or step of head 44 engages shoulder 46. In some embodiments, latch member 20 is inserted into recess 76 and window 50 of upper housing member 14 until end portions 54 engage, snap into, are received within, couple with, etc., windows 40. In some embodiments, a surface 58 of end portion 54 directly engages or contacts engagement surface 56 of interfacing portion 38.

Latch member 20 engages upper housing member 14 (at head 44 and shoulder 46) and secures or fixes with receiving member 22 (at end portions 54 and windows 40), according to some embodiments. Receiving member 22 engages, secures, or fixes with upper housing member 14 (e.g., at interfacing portions 38 and windows 64) and is fixedly coupled with lower housing member 12 (at the base portion at bottom end 32). In this way, lower housing member 12 and upper housing member 14 are fastened, secured, fixed, etc., to each other.

Advantageously, latch member 20 and receiving member 22 facilitate provide a secure connection between lower housing member 12 and upper housing member 14, according to some embodiments. In some embodiments, if housing 11 is tampered with, head 44 can be the first mode of failure. Advantageously, head 44 can be easily viewed from outside of housing 11, and if head 44 snaps, breaks, etc., while housing 11 is tampered with, the broken head 44 can be viewed and an inspector is visually notified that housing 11 has been tampered with. Advantageously, even if head 44 breaks due to tampering, upper housing member 14 is still secured with lower housing member 12 through interfacing portions 38 of receiving member 22.

Advantageously, the square or rectangular shape of head 44 and recess 76 facilitates preventing tampering, according to some embodiments. In some embodiments, the square or rectangular shape of head 44 and recess 76 makes it difficult to insert a screwdriver or a prying object, thereby facilitating a housing 11 that is tamper resistant. In some embodiments, the size of head 44 is tightly fit with recess 76 so that gaps between head 44 and recess 76 are minimal, thereby making it more difficult to insert a screwdriver or prying object into the gaps between head 44 and recess 76. In some embodiments, a fixation or tensile strength of receiving member 22 and latch member 20 is greater than strength of lower housing member 12 and/or upper housing member 14. In this way, if housing 14 experiences excessive or large amounts of prying or tensile force between lower housing member 12 and upper housing member 14 while being tampered with, lower housing member 12 and upper housing member 14 may deform before latch member 20 and/or receiving member 22 fail, thereby providing a visual indication that housing 11 has been tampered with.

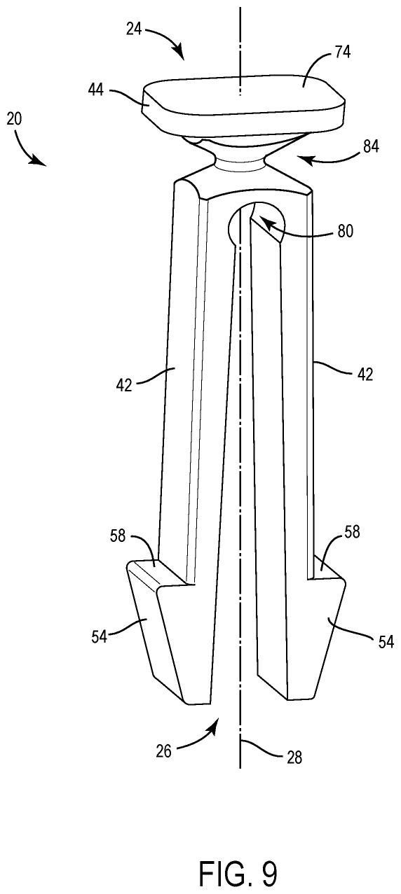

Referring now to FIG. 9, latch member 20 can include a neck, a recessed portion, a reduced diameter portion, a converging portion, a constricted portion, etc., shown as neck 84. Neck 84 can be positioned between head 44 and bendable elongated members 42. In some embodiments, neck 84 is positioned between head 44 and open space 80. Neck 84 can have a smallest cross sectional area that is less than a cross-sectional area of head 44. In some embodiments, neck 84 has a circular cross-sectional shape. In some embodiments, neck 84 has a rectangular, square, or irregularly shaped cross-sectional shape that is smaller than a cross-sectional area or “footprint” of head 44.

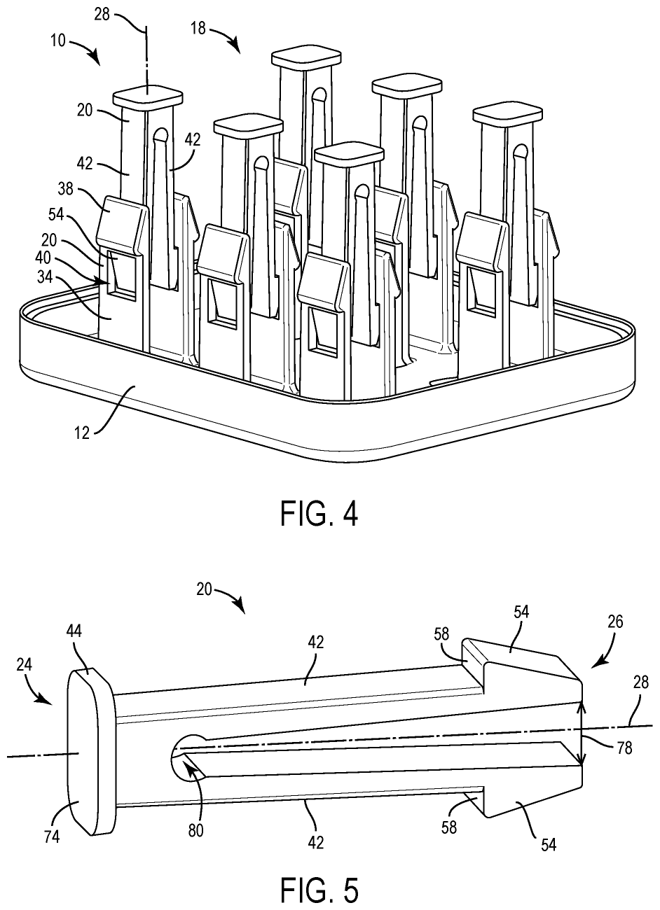

Referring particularly to FIG. 4, latch member 20 includes a recess, a cavity, an opening, a void space, etc., shown as open space 80, according to some embodiments. In some embodiments, open space 80 is configured to facilitate bending of bendable elongated members 42 during insertion of latch member 20. In some embodiments, a distance 78 between bendable elongated members 42 decreases as latch member 20 is inserted into inner volume 62. Once latch member 20 is inserted fully into inner volume 62, distance 78 can increase or return to a rest state as end portions 54 snap into windows 40.

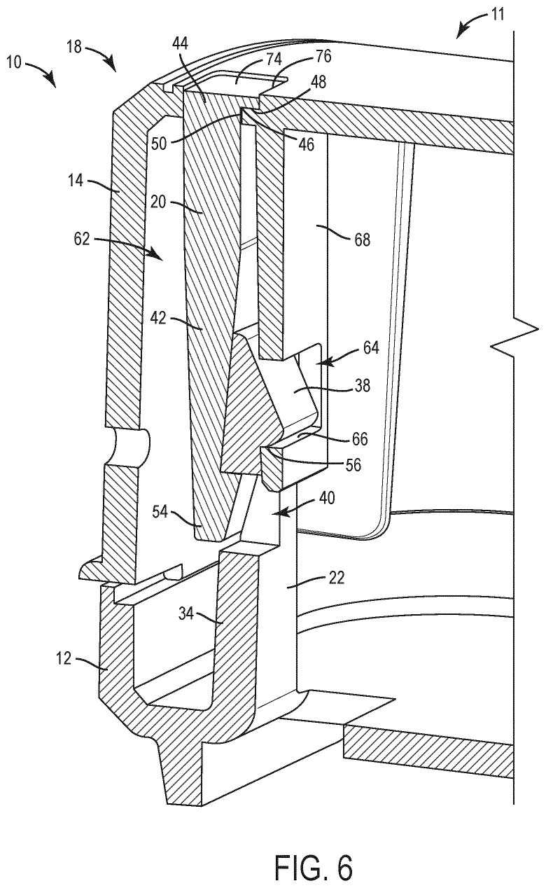

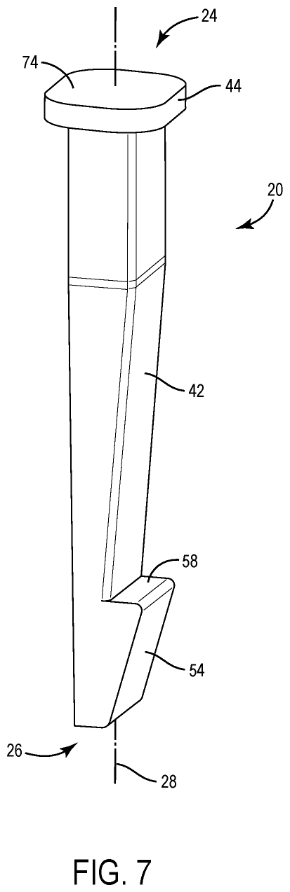

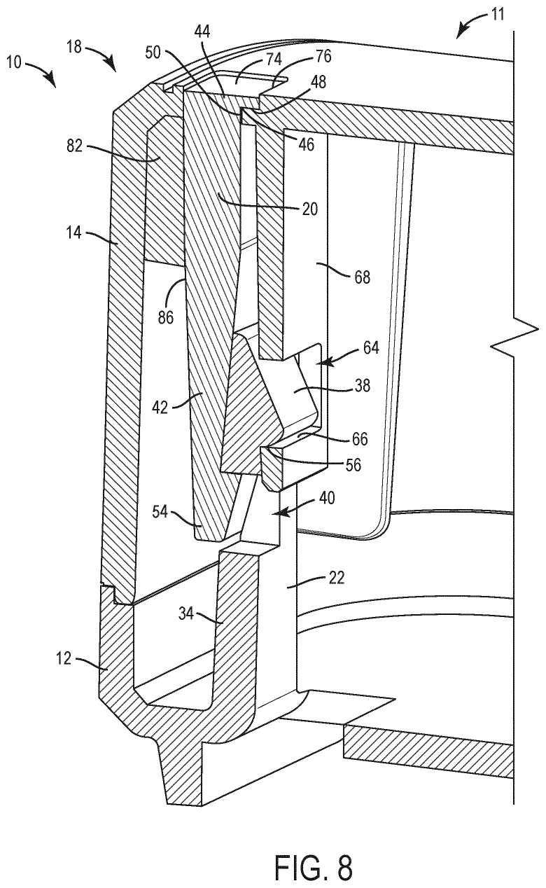

Referring particularly to FIGS. 6 and 7, interlocking member 18 is shown according to some embodiments. In some embodiments, latch member 20 includes only one bendable elongated member 42. In some embodiments, latch member 20 includes a flanged head 44 that defines a shoulder 46 along one or more sides of head 44. For example, head 44 can define shoulder 46 along three sides of head 44, two sides of head 44, only one side of head 44, etc. In some embodiments, head 44 has a shape that corresponds to the shape of recess 76. In some embodiments, head 44 is received within recess 76 such that outer surface 74 of head is sub-flush with the exterior or outer surface 52 of upper housing member 14. In some embodiments, upper housing member 14 includes a structural member, a rib, a support member, etc., shown as rib 82. Rib 82 can extend along a portion of a sidewall of upper housing member 14. In some embodiments, rib 82 extends between adjacent sidewalls of upper housing member 14 at a corner of upper housing member 14.

In some embodiments, shoulder 46 of head 44 is configured to engage, contact, couple with, etc., a corresponding shoulder of upper housing member 14 defined by window 50 of upper housing member 14. In some embodiments, upper housing member 14 includes a wall 68 that extends into an inner volume defined by lower housing member 12 and upper housing member 14. In some embodiments, wall 68 includes an aperture, a window, an opening, etc., shown as window 64. In some embodiments, window 64 extends through an entire thickness of wall 68. In some embodiments, window 64 is configured to receive, engage, etc., interfacing portion 38 of receiving member 22. In some embodiments, receiving member 22 is integrally formed with lower housing member 12. In some embodiments, receiving member 22 protrudes or extends from an inner surface of lower housing member 12 into the inner volume defined by lower housing member 12 and upper housing member 14. In some embodiments, receiving member 22 includes an angled end portion, shown as interfacing portion 38 that engages a shoulder, surface, face, periphery, step, edge, etc., of window 64 and is received within window 64. In some embodiments, receiving member 22 includes or defines window 40 that is configured to engage or receive end portion 54 of latch member 20.

The embodiment of interlocking member 18 as shown in FIGS. 6 and 7 is simplified relative to the embodiment shown in and described in greater detail above with reference to FIGS. 3-5. Specifically, receiving member 22 includes only one elongated member 34, one window 40, and one interfacing portions 38, according to some embodiments. Likewise, latch member 20 includes only one bendable elongated member 42 and one end portion 54, according to some embodiments.

Referring particularly to FIG. 7, latch member 20 is shown in greater detail, according to some embodiments. In some embodiments, latch member 20 includes head 44 at proximate end 24 and end portion 54 at distal end 26. End portion 54 has a hook shape with an angled outer surface that is configured to engage a corresponding surface of receiving member 22 as latch member 20 is inserted, according to some embodiments. In some embodiments, head 44 has a generally rectangular shape with rounded corners as shown in FIG. 7. In some embodiments, recess 76 has a similar or corresponding shape to head 44. Advantageously, this facilitates preventing latch member 20 from being removed from housing 11, according to some embodiments. In some embodiments, head 44 includes an edge that extends in a lateral direction. In some embodiments, the edge is configured to interface with, engage, contact, etc., a surface, edge, periphery, etc., of window 50. In some embodiments, the edge extends from a same side of latch member 20 from which end portion 54 extends/protrudes. In some embodiments, portions of latch member 20 that are between head 44 and end portion 54 are the “body” of latch member 20. The body can have a generally rectangular cross-sectional shape, an elliptical cross-sectional shape, etc. In some embodiments, the cross-sectional shape of the body is smaller than the cross-sectional shape of head 44.

In some embodiments, latch member 20 has a red color. In some embodiments, the red color of latch member 20 facilitates providing a visual indication that housing 11 has been tampered with. In some embodiments, the rectangular shape of head 44 of latch member 20 and the corresponding shape of recess 76 makes latch member 20 more difficult to remove and thereby facilitates a tamper resistant fixation between lower housing member 12 and upper housing member 14. In some embodiments, the size, shape, construction, etc., of head 44 and latch member 20 facilitates preventing latch member 20 from being drilled out. Even if latch member 20 is drilled out, lower housing member 12 and upper housing member 14 are still secured and fixed to each other through interfacing portion 38 of receiving member 22 and window 64. Latch member 20 and receiving member 22 can be used in housings specifically designed to accommodate them (e.g., if receiving member 22 is integrally formed with lower housing member 12). In some embodiments, latch member 20 and receiving member 22 can be used in housings with minimal modification.

Advantageously, interlocking members 18 facilitate preventing unauthorized access to components within housing 11 and provide visual indications if housing 11 is tampered with. Interlocking members 18 can provide a FIPS 140-2 Level 2. The various components of interlocking members 18 can be manufactured from a plastic. Advantageously, interlocking members 18 provide a cost effective FIPS 140-2 Level 2 retaining member that can be used to facilitate preventing unauthorized access to components within housing 11.

### Configuration of Exemplary Embodiments

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claim.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

What is claimed is:

1. A mechanical security feature for a housing, the mechanical security feature comprising:
a first interlocking member comprising:
a shoulder at a proximate end configured to engage a corresponding shoulder of a first housing member; and
a first hook at a distal end; and
a second interlocking member comprising a proximate end and a distal end wherein the second interlocking member extends from a second housing member into an inner volume of the housing defined by the first housing member and the second housing member, wherein the second interlocking member comprises:
a second hook at the distal end configured to engage a corresponding engagement surface of the first housing member; and
a window positioned between the distal end and the proximate end, wherein the window is configured to receive the hook of the first interlocking member to fix the first housing member with the second housing member.

2. The mechanical security feature of claim 1, wherein the second interlocking member is fixedly coupled with the second housing member.

3. The mechanical security feature of claim 1, wherein the second interlocking member is integrally formed with the second housing member.

4. The mechanical security feature of claim 1, wherein the first interlocking member is red.

5. The mechanical security feature of claim 1, wherein the first interlocking member comprises a third hook, wherein the first and third hooks are positioned at distal ends of a pair of elongated members of the first interlocking member.

6. The mechanical security feature of claim 5, wherein the first and third hooks are configured to engage windows of the second interlocking member positioned on opposite sides of the first interlocking member.

7. The mechanical security feature of claim 1, wherein the first interlocking member comprises a head at the proximate end that defines the shoulder of the first interlocking member.

8. The mechanical security feature of claim 7, wherein the head is a rectangular shape.

9. The mechanical security feature of claim 7, wherein the head is configured to be received within a recess of the first housing member having a corresponding shape.

10. The mechanical security feature of claim 1, wherein the corresponding engagement surface of the first housing member that the second hook of the second interlocking member engages is defined by an aperture in a wall that extends from the first housing member into the inner volume of the housing.

11. A mechanical security feature for a housing, the mechanical security feature comprising:
a first interlocking member comprising:
a surface at a proximate end configured to engage a corresponding contact surface of a first housing member; and
a first protrusion at a distal end; and
a second interlocking member comprising a proximate end and a distal end wherein the second interlocking member extends from a second housing member into an inner volume of the housing defined by the first housing member and the second housing member, wherein the second interlocking member comprises:
a second protrusion at the distal end configured to engage a corresponding engagement surface of the first housing member; and
a window positioned between the distal end and the proximate end, wherein the window is configured to receive the first protrusion of the first interlocking member to fix the first housing member with the second housing member.

12. The mechanical security feature of claim 11, wherein the second interlocking member is fixedly coupled with the second housing member.

13. The mechanical security feature of claim 11, wherein the second interlocking member is integrally formed with the second housing member.

14. The mechanical security feature of claim 11, wherein the first interlocking member is red.

15. The mechanical security feature of claim 11, wherein the first interlocking member comprises a third protrusion, wherein the first and third protrusions are positioned at distal ends of a pair of elongated members of the first interlocking member.

16. The mechanical security feature of claim 15, wherein the first and third protrusions are configured to engage windows of the second interlocking member positioned on opposite sides of the first interlocking member.

17. The mechanical security feature of claim 11, wherein the first interlocking member comprises a head at the proximate end that defines the contact surface of the first interlocking member.

18. The mechanical security feature of claim 17, wherein the head is a rectangular shape and is configured to be received within a recess of the first housing member having a corresponding shape.

19. The mechanical security feature of claim 11, wherein the corresponding engagement surface of the first housing member that the second protrusion of the second interlocking member engages is defined by an aperture in a wall that extends from the first housing member into the inner volume of the housing.

20. A housing comprising:
an upper housing member;
a lower housing member;
a first interlocking member comprising:
an engagement portion at a proximate end configured to engage a corresponding contact surface of the upper housing member; and
a first interlocking portion at a distal end;
a second interlocking member extending from the lower housing member into an inner volume of the upper housing member, the second interlocking member comprising:
an opening positioned between a proximate end and a distal end of the second interlocking member, wherein the window is configured to at least partially receive the first interlocking portion of the first interlocking member; and
a second interlocking portion, the second interlocking portion configured to engage a corresponding engagement portion of the upper housing member.
